(19) United States
(12) Patent Application Publication
(10) Pub. No.: US 2013/0086887 A1
(43) Pub. Date: Apr. 11, 2013

(54) Method For Reducing The Rate Of Exhaust Heat Loss

(71) Applicants: NATHANIEL D. BERGLAND, Denver, IA (US); Christopher M. Barber, Hudson, IA (US); Jarred M. Crouch, Waterloo, IA (US)

(72) Inventors: NATHANIEL D. BERGLAND, Denver, IA (US); Christopher M. Barber, Hudson, IA (US); Jarred M. Crouch, Waterloo, IA (US)

(21) Appl. No.: 13/268,257

(22) Filed: Oct. 7, 2011

(51) Int. Cl. F02B 47/08; F02B 37/22; F01N 3/023

(52) U.S. Cl. 60/274

(57) ABSTRACT

Disclosed is a method for reducing the rate of exhaust heat loss. The method comprises the steps of determining whether an engine is motoring and determining whether a diesel particulate filter needs to be regenerated. Further, the method comprises the step of closing an air throttle to a substantially closed position for reducing the flow of intake gas into the engine if the diesel particulate filter needs to be regenerated and if the engine is motoring. Further yet, the method comprises the step of opening the EGR valve to an at least partially open position for allowing the exhaust gas to recirculate through the engine if the diesel particulate filter needs to be regenerated and if the engine is motoring.

### FIELD OF THE DISCLOSURE

The present disclosure relates to a method for reducing the rate of exhaust heat loss. More specifically, the present disclosure relates to a method for reducing the rate of exhaust heat loss during motoring conditions.

### BACKGROUND OF THE DISCLOSURE

The Environmental Protection Agency has adopted successive tiers of engine emissions requirements. For a diesel engine to operate within these requirements, the diesel engine may have hydrocarbon dosing hardware, a diesel oxidation catalyst (DOC), and a diesel particulate filter (DPF). Successfully using these components requires the hydrocarbon dosing hardware to inject fuel into an exhaust line, at certain times, so that the fuel can oxidize across the DOC and generate high temperatures for regenerating the DPF. For this to occur, the DOC's inlet temperature may need to be 275° C. or higher, and the DPF's temperature may need to be 600° C. or higher.

Sometimes maintaining such temperatures is not possible, especially when fresh air flows through the engine and the engine is not receiving fuel (i.e., a motoring condition). A motoring condition may occur when an engine control unit is not demanding fuel. This may occur when, for example, a vehicle is coasting. What is needed is a method for reducing the rate of exhaust heat loss, during motoring conditions, until fuel flow to the engine resumes.

### SUMMARY OF THE DISCLOSURE

Disclosed is a method for reducing the rate of exhaust heat loss. The method comprises the steps of determining whether an engine is motoring and determining whether a diesel particulate filter needs to be regenerated. Further, the method comprises the step of closing an air throttle to a substantially closed position for reducing the flow of intake gas into the engine if the diesel particulate filter needs to be regenerated and if the engine is motoring. Further yet, the method comprises the step of opening the EGR valve to an at least partially opened position for allowing the exhaust gas to recirculate through the engine if the diesel particulate filter needs to be regenerated and if the engine is motoring.

During motoring conditions, this method reduces the mass flow of cool intake gas into the intake manifold and the engine. This reduces the rate of exhaust heat loss and promotes the conditions necessary for maintaining adequate DOC and DPF temperatures.

### BRIEF DESCRIPTION OF THE DRAWINGS

The detailed description of the drawings refers to the accompanying figures in which:

FIG. 1 is simplified schematic of an engine and an exhaust gas recirculation system (EGR system) under normal operating conditions;

FIG. 2 is a simplified schematic of the engine and the EGR system that illustrates the prior art's response to motoring conditions;

FIG. 3 is a simplified schematic of the engine and the EGR system that illustrates the disclosed response to motoring conditions, and

FIG. 4 is a flow chart of the disclosed method.

### DETAILED DESCRIPTION OF THE DRAWINGS

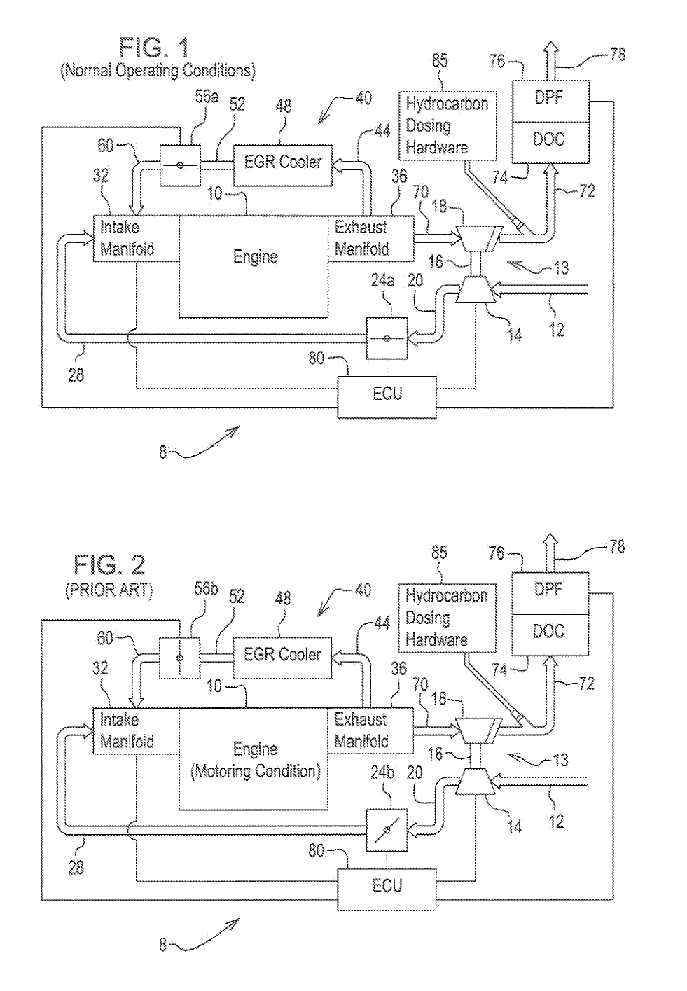

Referring to FIG. 1, there is shown a simplified schematic of a power system comprising 8 an engine 10 and an exhaust gas recirculation system (EGR system) 40 under normal operating conditions. A line 12 may be connected to a variable geometry turbocharger (VGT) 13. The VGT 13 may comprise a compressor 14, a shaft 16, and a turbine 18, wherein the shaft 16 connects the compressor 14 to the turbine 18. An air throttle 24a may be connected to the compressor 14 via a line 20, and the air throttle 24a may also be connected to an intake manifold 32 via a line 28. The engine 10 is connected to the intake manifold 32, and the engine 10 is also connected to an exhaust manifold 36. The EGR system 40 may be connected to the exhaust manifold 36. Exemplarily, the EGR system 40 comprises a line 44, an EGR cooler 48, a line 52, an EGR valve 56a, and a line 60. The line 44 may connect the EGR cooler 48 to the exhaust manifold 36, and the line 51 may connect the EGR valve 56a and the EGR cooler 48. Further, the line 60 may connect the EGR valve 56a to the intake manifold 32.

The turbine 18 may be connected to the exhaust manifold 36 via a line 70, and the turbine 18 may also be connected to a diesel oxidation catalyst 74 via a line 72. Hydrocarbon dosing hardware 85 may be connected to the line 72. The diesel oxidation catalyst 74 may connect to a diesel particulate filter (DPF) 76. A line 78 may connect to the DPF 76.

Further, an electronic control unit (ECU) 80 may be in communication with and/or in control of the various components mentioned, including the VGT 13, the DPF 76, the EGR valve 56a, the air throttle 24a, and the intake manifold 32. The ECU 80 may, for example, be capable of controlling the VGT 13, opening and closing the EGR valve 56a, determining whether the DPF 76 needs to be regenerated, and determining whether the intake manifold 32 is receiving fuel.

In the embodiment shown, under normal operating conditions, the intake gas enters line 12 and is compressed in the compressor 14. Next, the intake gas enters the line 20 and the air throttle 24a. Under normal operating conditions, the air throttle 24a is in an opened position. This allows the intake gas to flow into the line 28 and the intake manifold 32. The intake gas combines with fuel and combusts within the engine 10.

Some of the exhaust gas enters the EGR system 40, and some enters the line 70. The exhaust gas that enters the line 44 and the. EGR cooler 48, then, enters the line 52 and arrives at the EGR valve 56a. Under normal operating conditions—wherein fuel is entering the engine 10—the EGR valve 56a is open, which allows the exhaust gas, in the EGR system 40, to reenter the intake manifold 32. The exhaust gas that enters the line 70 passes through the turbine 18, which causes the shaft 16 and the compressor 14 to rotate. Next, the exhaust gas enters the line 72, the diesel oxidation catalyst 74, the DPF 76, and then exits via the line 78.

Referring to FIG. 2, there is shown a simplified schematic of the engine 10 and the EGR system 40 that illustrates the prior art's response to motoring. conditions. FIG. 1 and FIG. 2 have many components that are similar in structure and function, as indicated by the use of identical reference numbers where applicable. Further, the references to a, b, and c—with respect to the EGR valve 56a, b, and c and the air throttle 24a, b, and c—signify different operating positions, rather than different components.

A difference between the schematic shown in FIG. 1 and FIG. 2 is that the schematic in FIG. 1 represents a normal operating condition, while FIG. 2 represents a motoring condition. A motoring condition occurs when no fuel is being delivered to the engine 10. During motoring conditions, the method shown, in the prior art, was to partially close the air throttle 24b and to close the EGR valve 56b. The cool intake gases exit via the line 70, which quickly causes the temperature of the DPF 76 to, decrease. The temperature of the DPF 76 filter decreases rapidly to a temperature below what is necessary for regeneration. Otherwise, FIG. 1 and FIG. 2 have many components that are similar in structure and function, as indicated by the use of identical reference numbers where applicable. Further, the references to a, b, and c—with respect to the EGR valve 56a, b, and c and the air throttle 24a,b, and c—signify different operating positions, rather than different components.

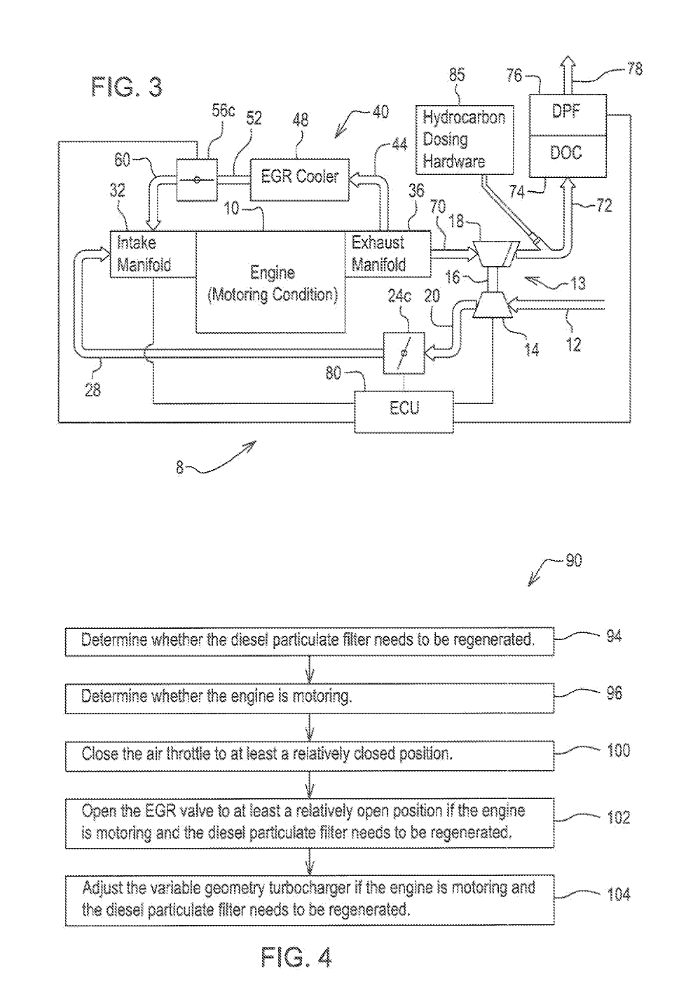

Referring to FIG. 3, there is shown a simplified schematic of the engine 10 and the EGR system 40 that illustrates the disclosed response to motoring conditions. FIG. 2 and FIG. 3 have many components that are similar in structure and function as indicated by the use of identical reference numbers. Like FIG. 2, FIG. 3 represents a motoring condition, but rather than illustrating the prior art's response, it illustrates the disclosed response.

Here, during motoring conditions, the air throttle 24c is in a substantially closed position for reducing the flow of intake gas into the engine 10 if the DPF 76 needs to be regenerated. The intake manifold 32 has an intake manifold pressure lower limit, and the substantially closed position may approximately correlate with the intake manifold pressure lower limit. Further, during motoring conditions, the EGR valve 56c is in an at least partially opened position if the DPF 76 needs to be regenerated. The partially opened position may be a fully opened position. Using this method reduces the mass flow of cool intake gas into the engine 10, and this, as a result, maintains high exhaust temperatures and promotes the conditions necessary for regenerating the DPF 76. Or stated differently, opening the EGR valve 56c allows the exhaust gas to recirculate, which allows the air throttle 24c to further reduce fresh air flow, while still maintaining minimum intake manifold pressure.

Referring to FIG. 4, there is shown a method 90 for reducing the rate of exhaust heat loss. Act 94 of the method is to determine whether the DPF 76 needs to be regenerated, and act 96 is to determine whether the engine 10 is motoring. Act 100 of the method is to close the air throttle 24c to a substantially closed position for reducing the flow of intake gas into the engine 10 if the DPF 76 needs to be regenerated and if the engine 10 is motoring. The intake manifold 32 has an intake manifold pressure lower limit, and the substantially closed position may approximately correlate with the intake manifold pressure lower limit.

The intake manifold pressure lower limit is a calibration guideline for preventing damage to the engine 10 and its hardware. If the intake manifold pressure drops below the intake manifold lower limit, the engine 10 and its hardware could be damaged in at least two ways. First, engine oil could be pulled past one or more valve stem seals (not shown) as the result of the pressure differential between the intake manifold 32 and the valve train (not shown). This leads to excessive oil consumption, and as a result of oil burning during combustion, ash accumulates in the DPF 76. Second, an intake manifold pressure that is too low could cause damage to the cylinders (not shown). This could occur, because the top piston ring (not shown) could float, as the piston (not shown) pulls air from the intake manifold 32, into the cylinder. The top piston ring is designed to seal by using the pressure of the intake gas, in the cylinder, to force the top piston ring against the cylinder. When the intake manifold pressure is too low, the top piston ring moves, resulting in unnecessary wear to the cylinder and unnecessary oil consumption.

Act 102 of the method is to open the EGR valve 56c to an at least partially opened position for allowing the exhaust gas to recirculate through the engine 10 if the DPF 76 needs to be regenerated and if the engine 10 is motoring. Act 104 of the method is to adjust the variable geometry turbocharger (VGT) 13 for preventing damage to the engine 10. The VGT 13 position is determined by operating below a maximum allowed engine delta pressure. The maximum allowed engine delta pressure is the difference between the pressure of the intake manifold 32 and the pressure of the exhaust manifold 36. If the engine delta pressure is too high, the valve train could sustain damage resulting from valve float.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

1. A method for reducing a rate of exhaust heat loss in a power system, the power system comprises an air throttle, wherein the air throttle allows intake of intake gas; an engine downstream of the air throttle, wherein the engine produces exhaust gas; an EGR valve downstream of the engine; and a diesel particulate filter downstream of the engine, the method comprising:
determining whether the engine is motoring;
determining whether the diesel particulate filter needs to be regenerated;
closing the air throttle to a substantially closed position for reducing the flow of intake gas into the engine if the diesel particulate filter needs to be regenerated and if the engine is motoring; and
opening the EGR valve to an at least partially opened position for allowing the exhaust gas to recirculate through the engine if the diesel particulate filter needs to be regenerated and if the engine is motoring.

2. The method of claim 1, wherein the power system further comprises a variable geometry turbocharger, the variable geometry turbocharger comprises a compressor, the compressor is upstream of the air throttle; and the method further comprising:
adjusting the variable geometry turbocharger for preventing damage to the engine if the engine is motoring.

3. The method of claim 1, wherein the power system further comprises an intake manifold downstream of the air throttle and upstream of the engine, and the method further comprising:
determining an intake manifold pressure lower limit, and
correlating the substantially closed position with the intake manifold pressure lower limit.

4. The method of claim 1, wherein the at least partially open position is a fully opened position.

5. A method for reducing a rate of exhaust heat loss in a power system, wherein the power system further comprises an air throttle, wherein the air throttle allows intake of intake gas; an engine downstream of the air throttle, wherein the engine produces exhaust gas; an EGR valve downstream of the engine, and the method comprising:
motoring the engine;
closing the air throttle to a substantially closed position for reducing the flow of the intake gas into the engine; and
opening the EGR valve to an at least partially opened position for allowing the exhaust gas to recirculate through the engine.

6. The method of claim 5, wherein the power system further comprises a variable geometry turbocharger, the variable geometry turbocharger comprises a compressor, the compressor is upstream of the air throttle, and the method comprising:
adjusting the variable geometry turbocharger for preventing damage to the engine.

7. The method of claim 6, wherein the power system further comprises an intake manifold downstream of the air throttle and upstream of the engine, and the method comprising:
determining an intake manifold pressure lower limit, and
correlating the substantially closed position with the intake manifold pressure lower limit.

8 The method of claim 5, wherein the at least partially open position is a fully opened position.

9. A method for reducing a rate of exhaust heat loss in a power system, comprising an air throttle, wherein the air throttle allows intake of intake gas; an intake manifold downstream of the air throttle, wherein the intake manifold has a manifold pressure lower limit; an engine downstream of the intake manifold, wherein the engine produces exhaust gas; an EGR valve downstream of the engine, and the method comprising:
motoring the engine;
closing the air throttle to a position that approximately correlates with the intake manifold pressure lower limit; and
opening the EGR valve to an at least partially opened position for allowing the exhaust gas to recirculate through the engine.

10. The method of claim 9, wherein the power system further comprises a variable geometry turbocharger, the variable geometry turbocharger comprises a compressor, the compressor is upstream of the air throttle, and the method comprising:
adjusting the variable geometry turbocharger for preventing damage to the engine.

11. The method of claim 9, wherein the at least partially opened position is a fully opened position.
